(19) United States
(12) Patent Application Publication
(10) Pub. No.: US 2005/0040697 A1
(43) Pub. Date: Feb. 24, 2005

(54) Vehicle wheel with an outer surface configured to simulate animal coverings

(76) Inventors: Leslie S. Carmona, Long Beach, CA (US); Frank J. Hodges, Yorba Linda, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/643,736

(22) Filed: Aug. 19, 2003

(51) Int. Cl. B60B 21/00

(52) U.S. Cl. 301/95.101

(57) ABSTRACT

The present invention comprises vehicle wheels wherein at least a portion of the outer surface of the wheel includes a pattern simulating animal skins. The animal skin pattern on the wheel may not necessarily cause a consumer to believe that the wheel is actually made of, or covered by animal skins, but it preferably includes a series of painted or etched markings, or indentations and/or imprints similar to those of animal skins. According to certain embodiments disclosed herein, the simulated animal skin surface of the wheel can be configured to resemble crocodile/alligator skins, zebra skins, tiger skins, cheetah skins, lizard skins and/or ostrich skins.

### BACKGROUND

1. Field of the Invention

This invention relates in general to the field of wheels for supporting vehicles, and in particular to surface patterns for such wheels.

2. Description of the Related Art

Exotic-looking wheels on passenger vehicles, such as cars and trucks, have grown in popularity in recent years. Such wheels have been produced with a myriad of different styles and patterns to appeal to a wide variety of vehicle owners. The wheels on a vehicle can dramatically affect the overall appearance and style of the vehicle. For example, a vehicle with a conservative appearance can be transformed into an exotic-looking vehicle merely by adding appropriately selected wheels.

Consumers have demonstrated that they want wheels that reflect their personality and lifestyle. Leather has long been a highly favored material for use in clothing, personal effects, and furniture. Leather connotes natural beauty, wildness, and freedom from restraint. These qualities are often part of the image sought to be achieved by those who purchase exotic-looking vehicle wheels. However, animal skins clearly would not have sufficient structural strength to support a vehicle. Thus, there is a need for a vehicle wheel with an appearance of animal skins that provides the necessary structural strength to support a vehicle.

### SUMMARY

The present invention comprises vehicle wheels wherein at least a portion of the outer surface of the wheel includes a pattern simulating animal coverings. The animal covering pattern on the wheel may not necessarily cause a consumer to believe that the wheel is actually made of, or covered by animal coverings, but it preferably includes a series of painted or etched markings, or indentations and/or imprints similar to those of animal coverings.

According to certain embodiments disclosed herein, the later surface of vehicle wheels can be configured to resemble the coverings of ostriches, crocodiles/alligators, zebras, lizards, tigers, and/or cheetahs. These are merely illustrative examples. Other types of animal skins are also encompassed by the present invention.

### BRIEF DESCRIPTION OF DRAWINGS

Having thus summarized the general nature of the invention, certain preferred embodiments and modifications thereof will become apparent to those skilled in the art from the detailed description herein having reference to the figures that follow, of which:

FIG. 1 is a front view of an embodiment of a wheel according to the present invention configured to simulate an ostrich-skin appearance.

FIG. 2 is a perspective view of the wheel of FIG. 1.

FIG. 3 is a front view of another embodiment of a wheel according to the present invention configured to simulate a crocodile/alligator skin appearance.

FIG. 4 is a cross-sectional view of the wheel of FIG. 3.

FIG. 5 is a detail view of a portion of the wheel of FIG. 3 encompassed by line 5;

FIG. 6 is a cross-sectional view of the portion of the wheel shown in FIG. 5, along line 6;

FIG. 7 is a front view of yet another embodiment of a wheel according to the present invention configured to simulate a zebra-hair appearance.

FIG. 8 is a cross-sectional view of the wheel of FIG. 7.

FIG. 9 is a detail view of a portion of the wheel of FIG. 7, encompassed by line 9.

FIG. 10 is a cross-sectional view of the portion of the wheel shown in FIG. 9, along line 10.

FIG. 11 is a front view of another embodiment of a wheel according to the present invention configured to simulate a lizard-skin appearance.

FIG. 12 is a cross-sectional view of the wheel of FIG. 11.

FIG. 13 is a detail view of a portion of the wheel of Figure, encompassed by line 13.

FIG. 14 is a cross-sectional view of the portion of the wheel shown in FIG. 13.

FIG. 15 is a front view of another embodiment of a wheel according to the present invention configured to simulate a tiger-fur appearance.

FIG. 16 is a cross-sectional view of the wheel of FIG. 15.

FIG. 17 is a detail view of a portion of the wheel of Figure, encompassed by line 17.

FIG. 18 is a cross-sectional view of the portion of the wheel shown in FIG. 17.

FIG. 19 is a front view of another embodiment of a wheel according to the present invention configured to simulate a cheetah-fur appearance.

FIG. 20 is a cross-sectional view of the wheel of FIG. 19.

FIG. 21 is a detail view of a portion of the wheel of FIG. 19, encompassed by line 21.

FIG. 22 is a cross sectional view of the wheel of FIG. 21 along line 22.

### DETAILED DESCRIPTION

With reference now to the attached figures, embodiments of vehicle wheels 20 with a surface 30 configured to simulate an animal covering will now be described. As used herein, “animal coverings” and/or “coverings” refers to animal skins, hair, or fur. The wheels illustrated herein have a lateral face diameter of about 17 inches. The present invention may be applied to vehicle wheels of all usable diameters. For the purposes of the present discussion, the wheel will be referred to as having a lateral side 32 (i.e. a side furthest away from the center of the vehicle to which the wheel may be mounted) and a medial surface or portion 34 (i.e. nearest the center of the vehicle). The wheels 20 also include circumferential rim surfaces 36 adapted to receive a tire in any manner available to the skilled artisan.

In a four-wheeled vehicle, each wheel will typically have only one lateral side. However, in a two-wheeled vehicle, such as a motorcycle, each wheel will have two lateral sides with a medial portion therebetween. As used herein, the term “lateral surface” is used in its ordinary sense and refers without limitation to any surface on a lateral side of the wheel. Although the following discussion is presented in the context of a wheel with one or more lateral surfaces adapted to simulate the appearance of an animal covering surface, other surfaces, such as medial (inner) surfaces and/or outer circumferential surfaces can alternatively be so adapted. Additionally, although the attached figures show wheels configured to be used in a four-wheeled passenger vehicle, those of skill in the art will recognize that embodiments of the present invention can also be applied to motorcycle wheels, or wheels for other vehicles.

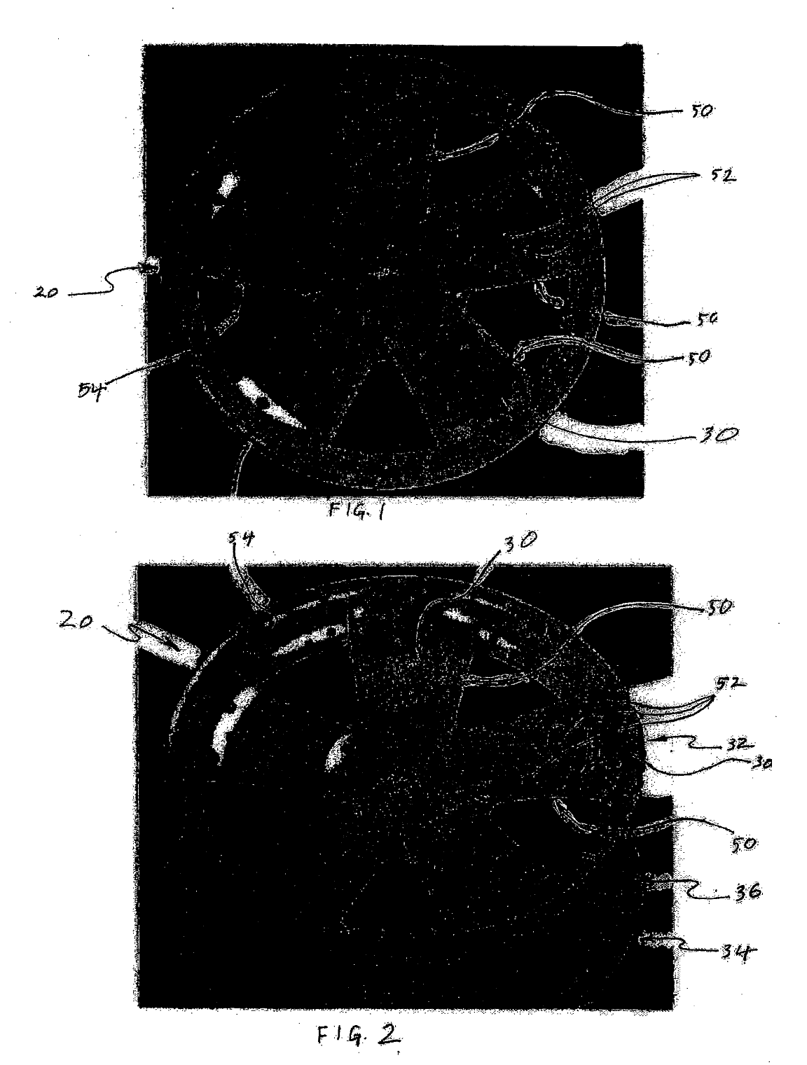

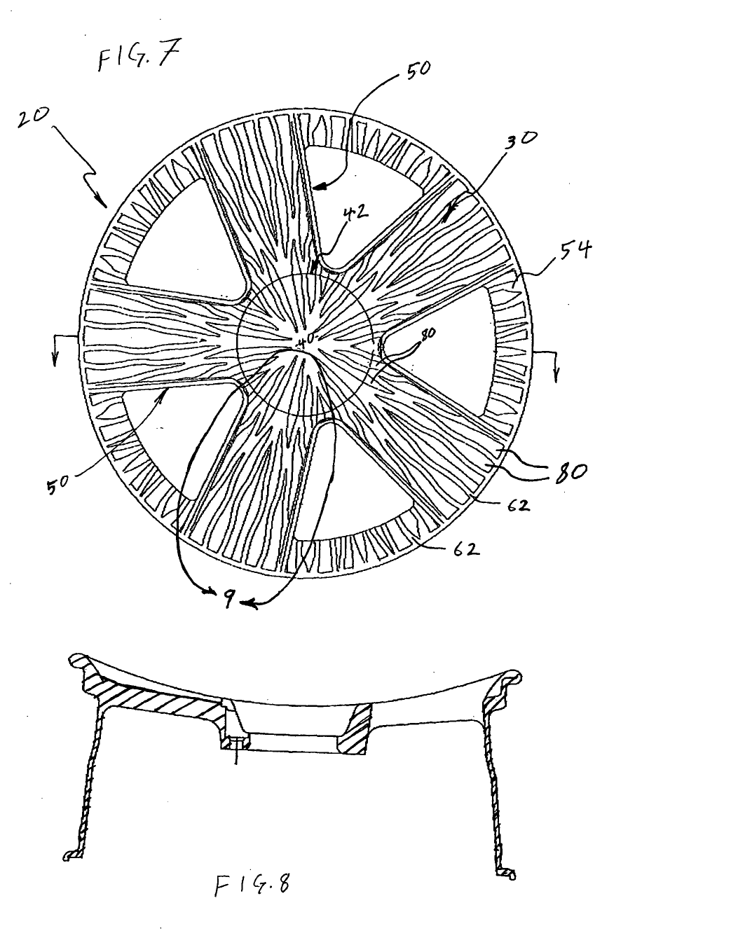

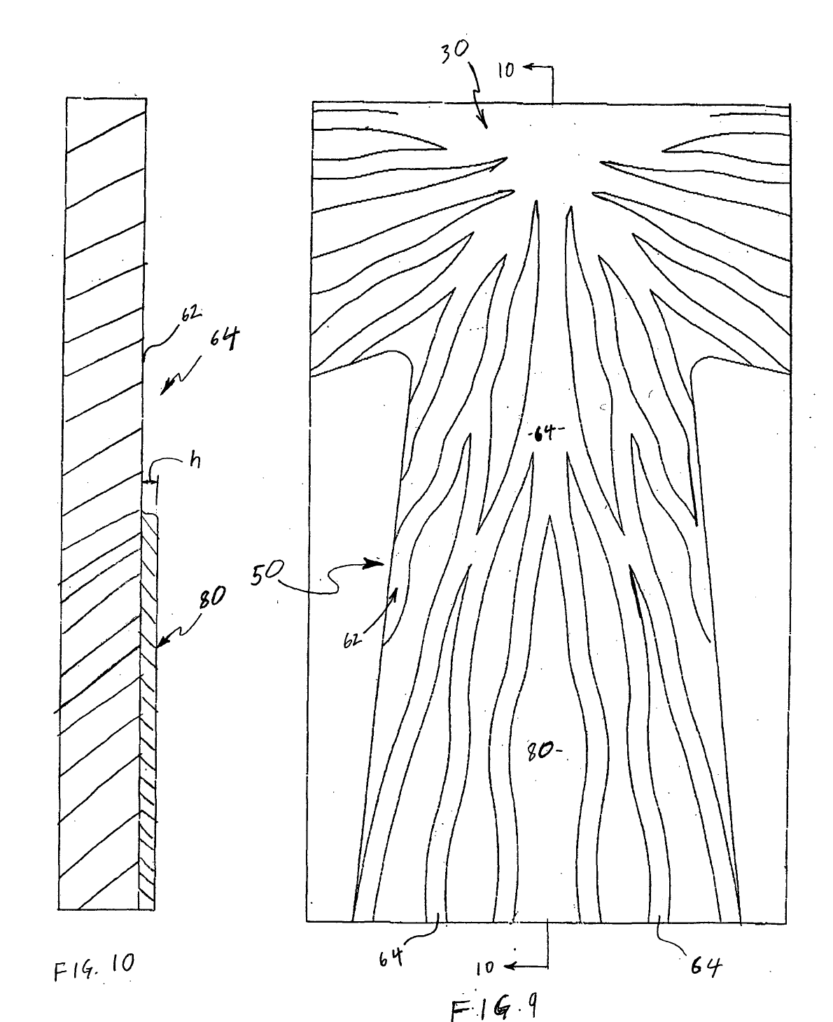

As illustrated in FIGS. 1-10, the lateral side 32 of a wheel 20, which is generally made of metal (such as aluminum or aluminum alloys), can be configured to include surfaces that simulate the natural patterns on animal coverings. Examples of animal coverings patterns simulated on wheel surfaces are described below. In each embodiment of the present invention, the animal patterns can be provided on at least a portion of one or more of the spokes, the central hub, the regions between the spokes, and/or the outer circumferential rim of the wheel face.

In one embodiment, the appearance of leather is imparted to a metallic wheel surface by providing a plurality of sections in contrasting colors and/or shades of gray in order to present an appearance which is visually similar to a leather surface, such as a crocodile/alligator skin, a zebra skin, or an ostrich skin. For example, in one embodiment, a pattern can comprise surfaces with a chrome finish contrasted against surfaces with a brushed metal finish. In another example, a brushed metal surface may be contrasted against a black or darker gray surface. Alternatively, surfaces of a wheel adapted to simulate an animal appearance may comprise surfaces with various anodized or painted colors.

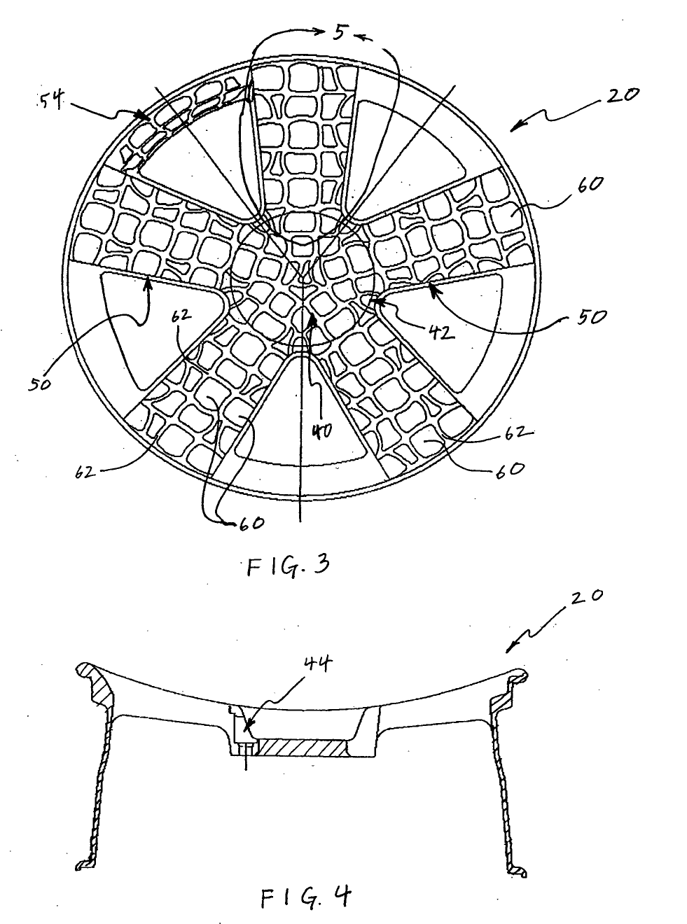

In some embodiments, the central hub portion 40 of the wheel 20 can include a leather-simulating pattern. For example, as illustrated in FIG. 3, a removable cap 42 can be provided to obscure the holes 44 and/or nuts and bolts (not shown) used for securing the wheel 20 to the vehicle. Such a cap 42 can include a continuation of the leather pattern as shown. If desired, the cap 42 can also include features to ensure accurate rotational positioning of the cap so that the continuity of the pattern is maintained. Alternatively, the wheel surface can comprise a continuous patterned surface with bolt holes formed at appropriate locations. In all of the embodiments, the animal-simulating design can also be formed on a detachable wheel face such as a hub cab.

FIG. 1 illustrates a wheel 20 with a plurality of radially-extending segments or spokes 50 with lateral surfaces 30 adapted to simulate an ostrich skin leather. The lateral surfaces 30 of the spokes 50 comprise a plurality of convex protrusions 52. The protrusions 52 are generally dome-shaped, and are provided in various sizes and positions so as to simulate the appearance of a tanned ostrich skin.

The protrusions 52 can be formed by machining or forging the lateral surfaces of the wheel 20. In alternative embodiments, the pattern can be formed by casting or other suitable molding processes. In still further alternative embodiments, the ostrich leather pattern may comprise a plurality of concave depressions in a similar pattern and formed by any suitable process.

As shown in FIG. 1, the protrusions 52 are preferably situated in a relatively ordered pattern with some degree of randomness. The amount of space between, and relative angular positioning of, adjacent protrusions 52 preferably varies over a particular range as shown. For example, in the wheel illustrated in FIG. 1, the distances between adjacent protrusions 52 preferably varies between about ½ inches and about 2 inches, and more preferably between about ¾ inch and about 1¼ inches. Other distances within or beyond these ranges are encompassed by the present invention. The overall density of protrusions 52 across the surface of the wheel is preferably relatively constant. Each protrusion 52 is preferably shifted a relatively small distance from where it would otherwise be positioned in a more orderly, symmetrical arrangement such as a grid.

Similarly, the width or diameter of each protrusion 52 preferably varies over a particular range. For example, in the wheel illustrated in FIG. 1, the width of each protrusion preferably varies between about ⅛ inch to about ½ inch. In addition, the protrusions 52 also need not be circular as viewed from above, and preferably comprise somewhat irregular shapes. The irregularity of the pattern leads to a more natural leather-type appearance.

If desired, the protrusions 52 can be shaded or colored to contrast against the surrounding surface. Such shading can be provided in addition to any contrast provided by the convexity or concavity of the protrusions. For example, in one embodiment, the protrusions comprise a brushed surface finish and the surrounding surface comprises a polished chrome surface.

FIG. 3 illustrates an embodiment of a wheel 20 comprising a lateral surface 30 adapted to simulate the appearance of a crocodile/alligator skin leather. As illustrated, the leather-simulating surfaces preferably include the radially outer surfaces 30 on each of the spokes 50 of the wheel 20, and portions of the inner rim surfaces 54 between the spokes 50. In further embodiments, the central hub portion 40 of the wheel can include a leather-simulating pattern as well.

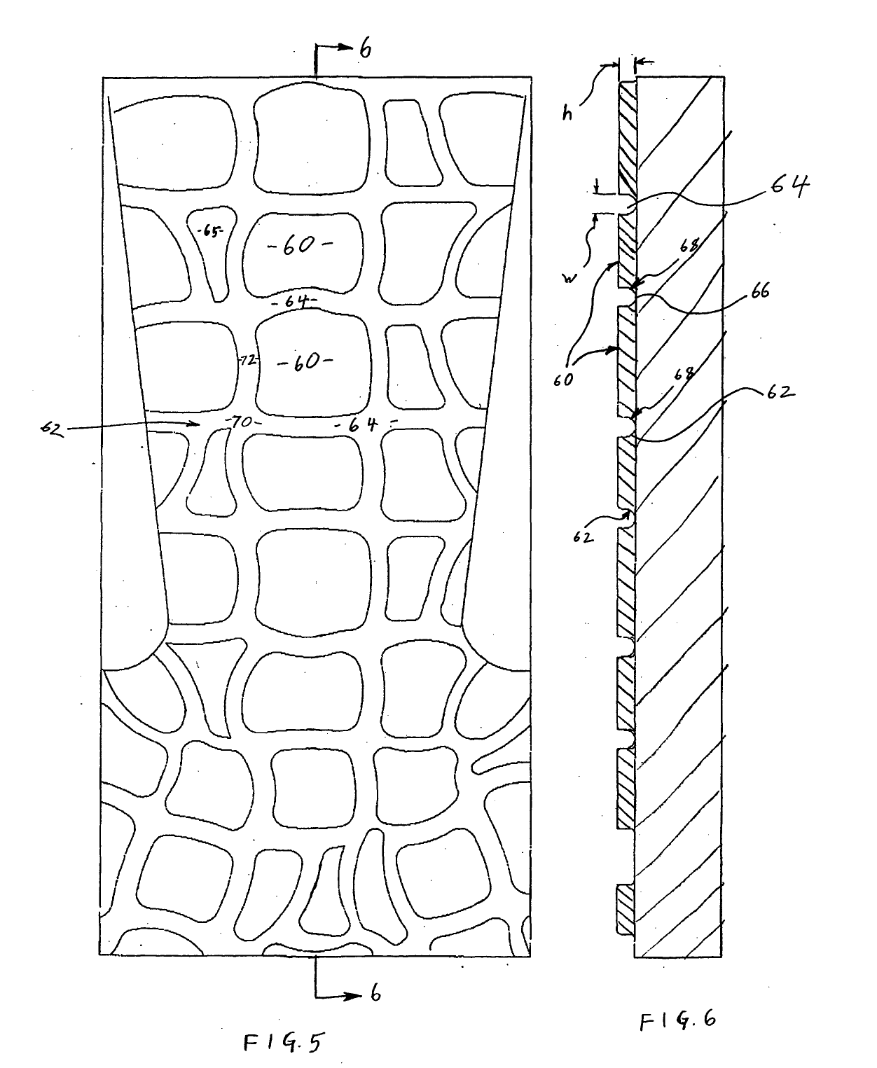

As illustrated in FIGS. 3 and 5, the leather-simulating surfaces of the present embodiment generally include a plurality of cells 60, many of which have three or four sides. The cells 60 comprise a variety of shapes and sizes, and are arranged so as to present a pattern which is substantially similar to the pattern typically associated with crocodile/alligator skins. As illustrated, certain of the cells 60 have at least two non-straight sides. Preferably, a majority of the cells 60 are four-sided, and each of the four sides of the cells 60 approximates a straight line, but has some degree of curvature In the illustrated embodiment, the sides of the cells preferably range from about ¼ inch to about 1 inch. The curvature of the sides of adjacent cells 60 are often complementary. For example, the side of one cell 60 may be concave and the nearest side of an adjacent cell 60 may be convex. Certain cells with three sides 65 (FIG. 5) and other numbers of sides are also preferably interspersed in the pattern. The overall arrangement of cells 60 is preferably not precisely symmetrical, but has a degree of order that creates the appearance that the ratio of the area of cells 60 to the overall surface are of the portion simulating the animal pattern is relatively constant.

In one embodiment, the cells 60 can comprise a color or shade that contrasts against a color or shade of the surfaces 62 between the cells 60. For example, in the case of a wheel 20 having surfaces simulating a crocodile/alligator skin, the cellular shapes 60 can comprise a light colored surface, and the surfaces 62 between the cellular shapes 60 can comprise darker colored surfaces. If desired, the colored surfaces can include further shading so as to provide non-uniform coloring across the pattern. As described above, such coloring or shading can be provided by varying a surface finish of the metallic surfaces, painting, anodizing, or other appropriate method.

According to one embodiment, as illustrated in FIGS. 5 and 6, the surfaces 62 between the cells 60 can have a depth to create channels or grooves 64 between the cells 60. The depth of the grooves is preferably sufficiently large that the material of the cells 60 is not worn too thin by polishing. However, making the grooves too deep can create difficulties in molding or machining the patterned surface. For example, in some embodiments as shown in FIG. 6, the cells 60 can be elevated above the bottom 66 of the grooves 64 by a height h of about 1/32 inch to about ½ inch, more preferably between about 1/16 inch and about ¼ inch, and most preferably about ⅛ inch. As can be seen in FIG. 5, a portion 70 of a groove between three or four cells 60 will have a larger area than a portion 72 of a groove between two shapes. These preferred ranges apply to all embodiments of the present invention disclosed herein. In embodiments comprising multiple-tiered surfaces (e.g., three tiers comprising a depressed portion, an intermediate portion, and a raised portion), the foregoing ranges would apply to the difference between the top of the raised portion and the bottom of the depressed portion. The differences between the depths and heights of the surface patter of the present invention can be within or beyond these ranges.

The grooves 64 between the cells 60 can comprise filleted corners 68 as shown in FIG. 6, or the corners could alternatively be substantially more square as desired. A filleted corner 68 can be provided with a fillet radius of between about 0.050″ and about 0.10″ as desired in order to provide the desired visual effect. In one preferred embodiment, the fillet radius is about 0.080″. In still further alternative embodiments, the transition between the grooves and the raised sections can be formed with substantially perpendicular edges meeting in a substantially sharp corner.

According to one embodiment, the grooves and cellular shapes are formed by machining the grooves into at least a portion of the lateral surface of a wheel. In alternative embodiments, an animal covering pattern can be formed by casting or otherwise molding the wheel with the desired pattern. Alternatively still, an animal covering pattern can be formed on an existing wheel surface by molding or depositing additional material onto the wheel surfaces in the desired pattern. The shape and machined surface finish of the grooves 64 will also provide some amount of visual contrast between the cells 60 and the grooves 64 between them.

FIGS. 7-10 illustrate embodiments of wheels with a zebra skin pattern formed on a visible surface 30 of the wheel 20. As illustrated, the simulated zebra skin surfaces comprise a plurality of radially-extending stripe segments 80. Each of the stripe segments 80 comprises a substantially irregular, generally long and narrow shape. In the illustrated embodiment, the lenght of the stripe segments 80 preferably ranges between about 3 inches and about 5 inches. Each of the stripe segments 80 also preferably has pointed first and second ends. The sides of the stripe segments 80 are preferably curvilinear. The distance between the sides of the stripe segments 80 preferably varies across the segments 80, and preferably reaches a maximum value over at least two points across the segments 80. In the illustrated embodiment, the maximum distance between the sides of the stripe segments 80 varies between about ¼ inch and about ¾ inch. The segments 80 are preferably arrayed so that their longitudinal axes are oriented toward or near the center of the face of the wheel.

The positioning of the various segments 80 is preferably not precisely symmetrical, but, as with the other patterns described herein, it conveys a degree of order and balance. The stripe segments 80 can alternatively be thicker, fewer in number, or longer than the strip segments 80 illustrated herein.

As in the previous embodiments, the stripe segments can comprise elevated sections separated by depressed grooves 64. The grooves can vary in width and depth in order to achieve the desired pattern. Also, as described above, the stripe segments can comprise contrasting coloring or shading to further distinguish the stripe segments 80 from the grooves.

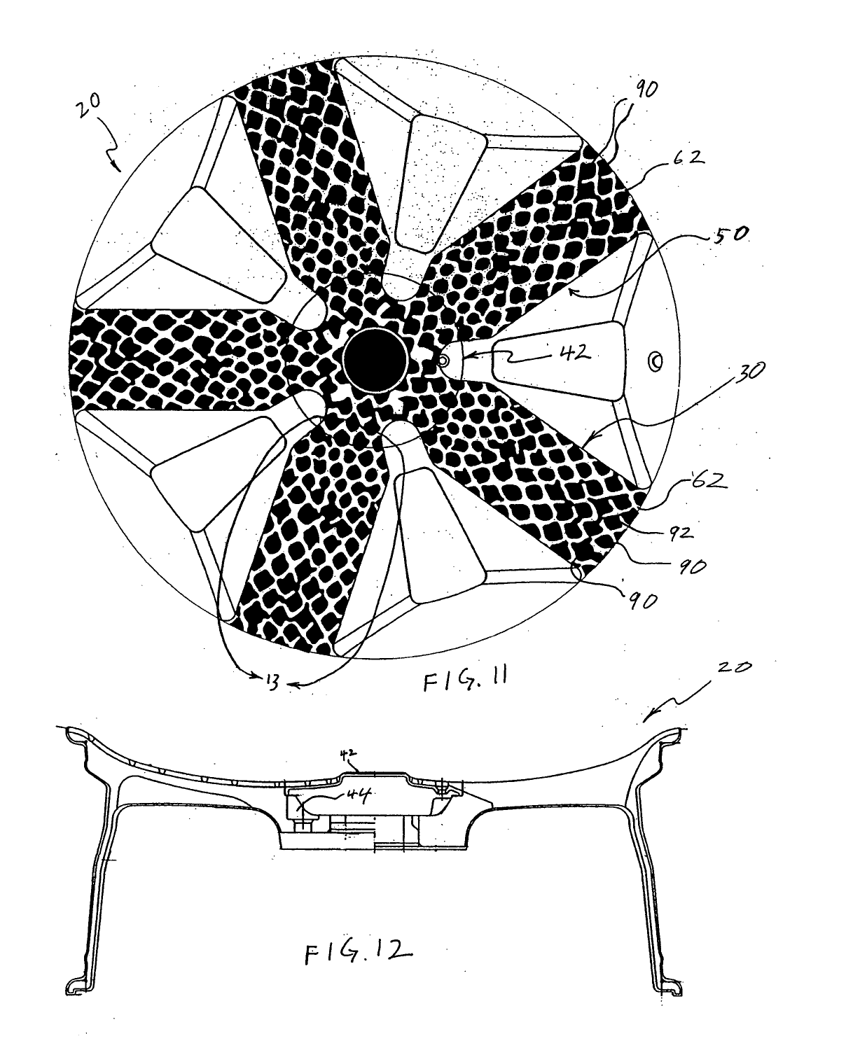

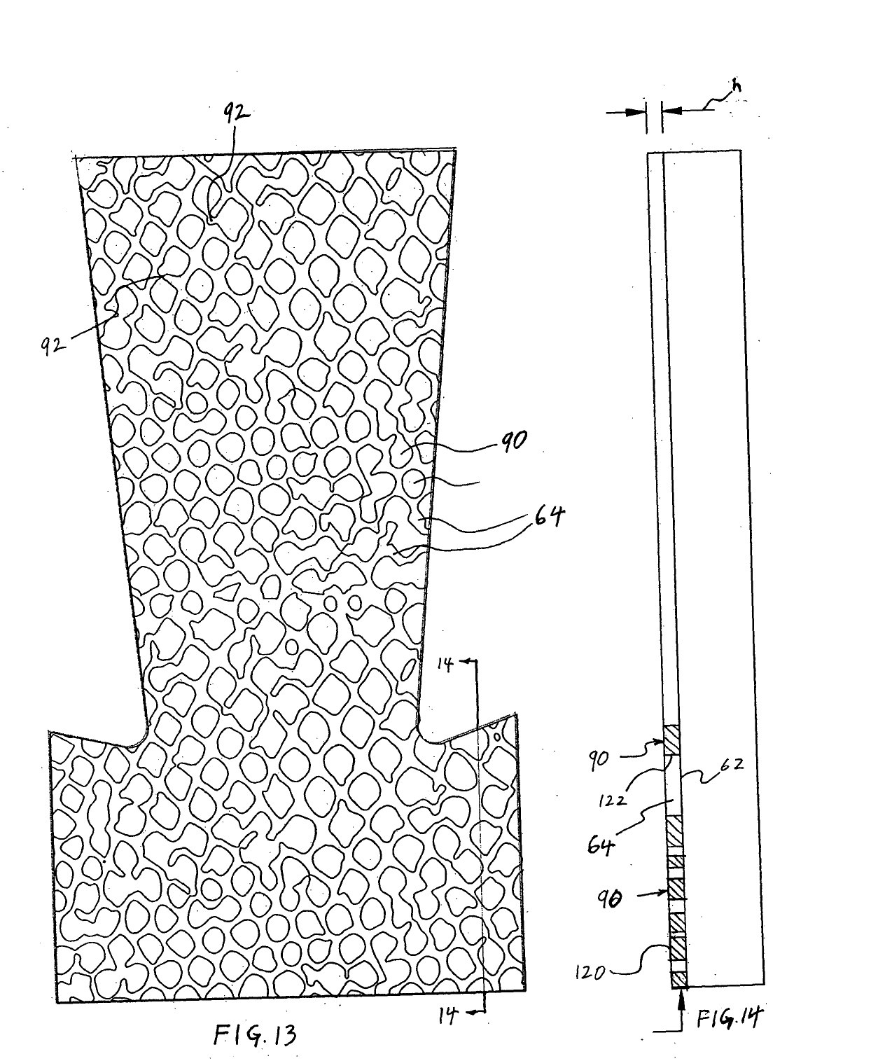

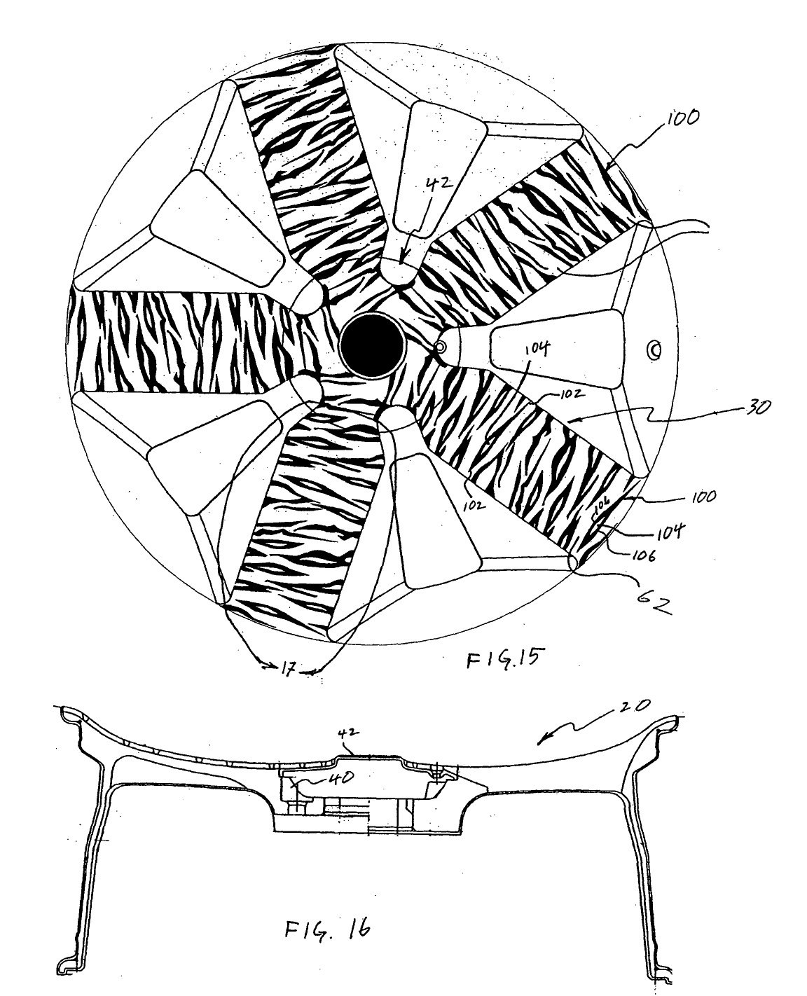

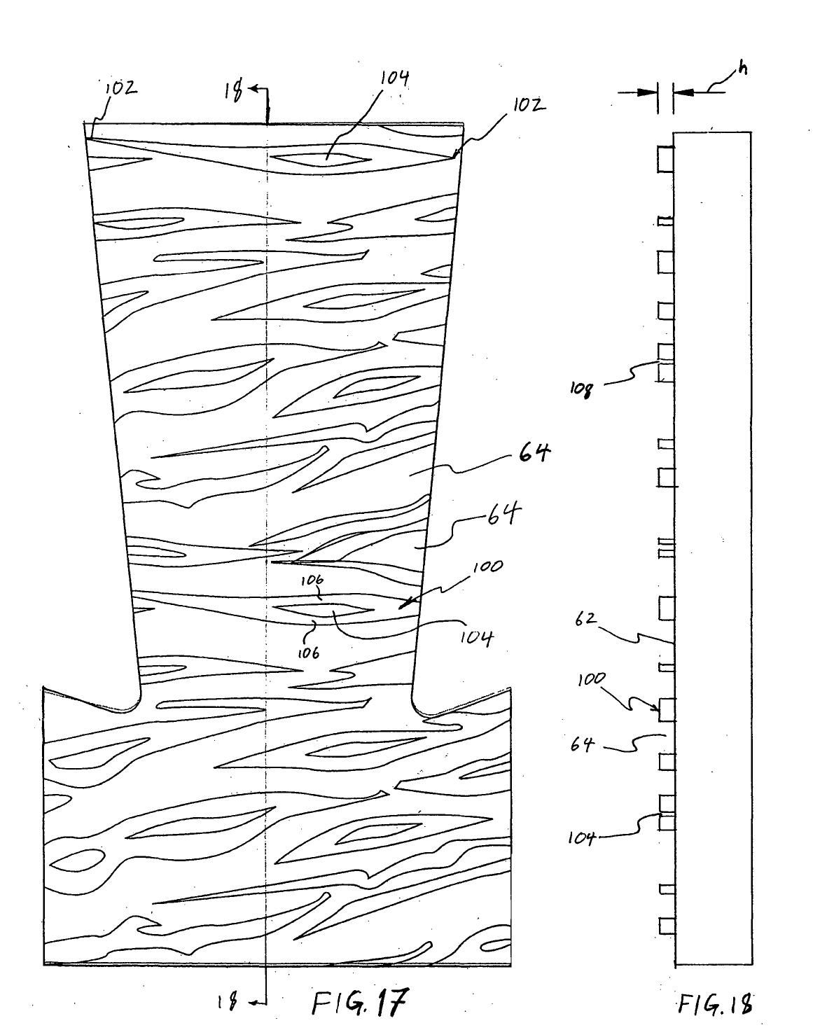

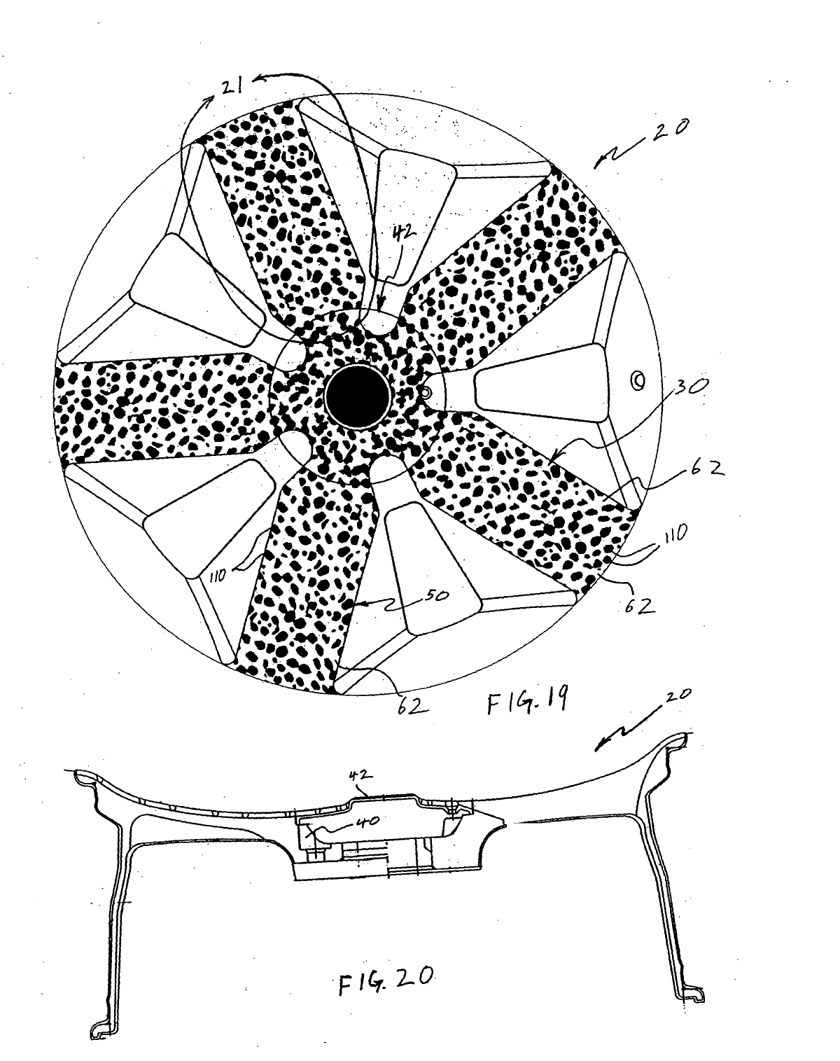

FIGS. 11-14 illustrate embodiments of wheels with a lizard skin pattern formed on visible surfaces 30 of the wheel 20. As shown, the lizard pattern generally comprises a plurality of amorphously-shaped sections 90 with spaces 62 of varying sizes between them. As shown, the lizard skin pattern preferably includes linking sections 92 that extend between and “bridge” two or more of the amorphous sections 90. The widths of the amorphous sections 90 (i.e., the maximum length between any two points along the perimeter of the shape) preferably ranges between about ¼ inch and about ¾ inch. The amorphous sections 90 are preferably generally circular with at least one or more circumferential aberrations. The amorphous sections 90 preferably resemble circular bodies that have been stretched or skewed.

As with other patterns described herein, The overall arrangement of the amorphous sections is preferably not precisely symmetrical, but has a degree of order that creates the appearance that the density of the pattern is relatively constant across the simulated lizard skin surface. The shape of each amorphous section 90 is preferably related in some way to the shapes of one or more adjacent amorphous sections 90. For example, a plurality of amorphous sections 90 are preferably aligned so that imaginary lines drawn across their respective maximum widths are approximately parallel or converge in the direction of a common point. As shown in FIG. 11, the surfaces of the amorphous sections can be painted or otherwise imparted with a contrasting color relative to the surrounding spaces.

As in the previous embodiments, the amorphous sections can comprise elevated sections separated by depressed grooves 64. The grooves between the elevated amorphously shaped sections 90 can vary in width and depth, such as with the ranges previously disclosed, in order to achieve the desired pattern.

FIGS. 15-18 illustrate an embodiment of a wheel with surfaces 30 configured to simulate an appearance of tiger fur. The tiger fur simulating surfaces generally comprise a plurality of stripe segments 100 preferably oriented with their longitudinal axes perpendicular to the radius of the wheel. The ends 102 of the stripe segments 100 preferably narrow to points, with the central sections widening between the pointed ends 102. In the illustrated embodiments, the length of each stripe segment 100 is preferably in the range of about 1-¼ inches to about 3 inches, and the maximum width of each stripe segment 100 is preferably in the range of about ¼ inch to about ¾ inch. Other lengths and widths within and beyond these ranges are encompassed by the present invention. Some of the tiger stripe segments 100 also preferably include “open” central portions 104 that extend between solid line portions 106 of the stripe segments 100. A number of the stripe segments 100 are preferably positioned so as to give the appearance that the segments 100 are larger than the width of the spokes and thus continue off the edge of the spokes.

The positioning of the various segments 100 is preferably not precisely symmetrical, but, as with the other patterns described herein, it conveys a degree of order and balance. The stripe segments can alternatively be thicker, fewer in number, or longer than the stripe segments 100 illustrated in FIGS. 15-18.

With reference to FIGS. 17 and 18, the stripe segments 100 can comprise elevated sections separated by depressed grooves 64. Additionally, the central portions 104 can also include depressed grooves 108 with a lower elevation than the stripe segments 100 as shown in FIG. 18. The grooves 64 can vary in width and depth in order to achieve the desired pattern. Also, as described above, the stripe segments can comprise contrasting coloring or shading to further distinguish the stripe segments 80 from the grooves.

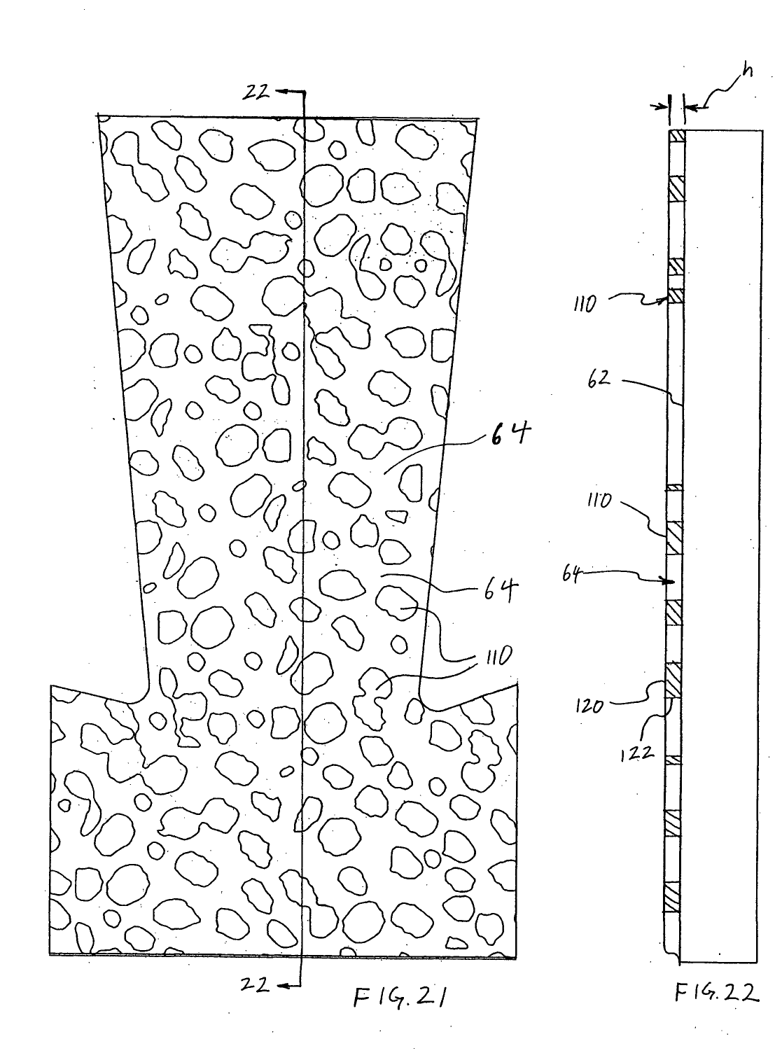

FIGS. 19-22 illustrate embodiments of a wheel with visible surfaces 30 configured to simulate an appearance of cheetah fur. The cheetah fur simulating surfaces generally comprise a plurality of amorphously-shaped sections 110 of varying shapes and sizes. As shown, the cheetah fur pattern preferably comprises amorphous sections 110 of substantially smaller size and in a substantially less dense pattern than the lizard-skin pattern of FIGS. 11-14. For example, in the illustrated embodiment, the width of the amorphous sections 110 preferably varies between about ⅛ inch and about ½ inch. The cheetah pattern preferably has a greater degree of randomness than the lizard-skin pattern in that the respective shapes of adjacent amorphous sections 110 are not generally related. Moreover, the distance between amorphous sections 110 is preferably greater and varies over a wider range.

As with other patterns described herein, The overall arrangement of the amorphous sections in the cheetah fur pattern is preferably not precisely symetrical, but has a degree of order that creates the appearance that the density of the pattern is relatively constant across the simulated cheetah-fur surface. As shown in FIG. 19, the surfaces of the amorphous sections can be painted or otherwise imparted with a contrasting color relative to the surrounding spaces.

As in the previous embodiments, the cheetah fur pattern can comprise elevated sections separated by depressed grooves 64. The grooves between the elevated amorphously shaped sections 110 can vary in width and depth in order to achieve the desired pattern. As shown, the cheetah fur pattern comprises a substantially less dense arrangement of raised sections, and thus the grooves between the elevated sections are relatively wide in certain areas.

In one preferred embodiment, the surface of a metallic vehicle wheel can be adapted to simulate an animal covering surface by machining the surface to remove material or by molding or casting to add material in order to create a pattern of raised surfaces adjacent to recessed surfaces. The shape and arrangement of the pattern can be varied to simulate the appearance of different animal coverings.

With reference to FIG. 22, the top surfaces 120 of the elevated sections of any of the above embodiments can be substantially perpendicular to the side surfaces 122 of the sections. This provides for substantially distinct contrast between the elevated sections and the grooves or channels therebetween. As mentioned previously, the transition between the bottom of the grooves 64 and the sides of the elevated sections can include a filleted radius (e.g. see FIG. 6) or a substantially sharp corner (e.g. see FIG. 22).

The embodiments of the present invention share in common a particularly high degree of design density for a wheel surface; that is, the amount of ornamentation (i.e., the number of surfaces that contrast in texture, color, elevation, etc. per unit of area) is very high.

In further embodiments, each of the patterns described above and any other animal patterns made in accordance with the teachings of the present invention could alternatively be inverted such that the illustrated elevated pattern sections comprise a plurality of depressions between raised walls in place of the illustrated grooves.

Although certain embodiments and examples have been described herein, it will be understood by those skilled in the art that many aspects of the methods and devices shown and described in the present disclosure may be differently combined and/or modified to form still further embodiments. Additionally, it will be recognized that the methods described herein may be practiced using any device suitable for performing the recited steps. Such alternative embodiments and/or uses of the methods and devices described above and obvious modifications and equivalents thereof are intended to be within the scope of the present disclosure. Thus, it is intended that the scope of the present invention should not be limited by the particular embodiments described above.

1. A wheel adapted to be attached to a vehicle for supporting the weight of the vehicle, the wheel comprising:
a substantially circular rim adapted to receive a tire; and
a lateral surface adapted to face outwardly from a vehicle when mounted thereon, at least a portion of the lateral surface being configured to simulate an appearance of an animal covering that has been removed from an animal and placed on the wheel.

2. The wheel of claim 1 wherein at least a portion of the lateral surface is configured to simulate the appearance of ostrich skin.

3. The wheel of claim 2 wherein the ostrich-skin simulation surface comprises a plurality of quasi-circular protrusions with bases and pointed or rounded ends, the bases of the protrusions being larger in width than the ends of the protrusions.

4. The wheel of claim 1 wherein at least a portion of the lateral surface is configured to simulate the appearance of alligator or crocodile skin.

5. The wheel of claim 4, wherein the alligator or crocodile simulation surface comprises a plurality of cellular shapes.

6. The wheel of claim 5, wherein a majority of the cellular shapes comprise three-sided or four-sided shapes with substantially non-straight edges.

7. The wheel of claim 1 wherein at least a portion of the lateral surface is configured to simulate the appearance of zebra hair.

8. The wheel of claim 7 wherein the zebra-hair simulation surface comprises a plurality of stripe segments with their longitudinal dimensions substantially greater than their transverse dimensions, and their longitudinal axes generally oriented toward the center of the lateral surface of the wheel.

9. The wheel of claim 8 wherein a plurality of the stripe segments comprise a varying width across their transverse dimensions.

10. The wheel of claim 1 wherein at least a portion of the lateral surface is configured to simulate the appearance of lizard skin.

11. The wheel of claim 10 wherein the lizard-skin simulation surface comprises a plurality of amorphous-shaped sections.

12. The wheel of claim 11 wherein the lizard simulation surface comprises a plurality of bridges between two or more amorphous-shaped sections

13. The wheel of claim 11 wherein a plurality of the amorphous-shaped sections are oriented so that imaginary lines drawn across their respective maximum widths are generally parallel.

14. The wheel of claim 1 wherein at least a portion of the lateral surface is configured to simulate the appearance of tiger fur.

15. The wheel of claim 14 wherein the tiger-fur simulation surface comprises a plurality of stripe segments extending generally perpendicularly to the radius of the wheel.

16. The wheel of claim 15 wherein a plurality of the stripe segments include at least one open area within each stripe segment.

17. The wheel of claim 1 wherein at least a portion of the lateral surface is configured to simulate the appearance of cheetah fur.

18. The wheel of claim 16 wherein the cheetah-fur simulation surface comprises a plurality of amorphous sections, the respective widths of the amorphous sections being comparable in size to the distance between adjacent amorphous sections.

19. The wheel of claim 18 wherein the surface area of a plurality of amorphous sections is at least three times larger than the surface area of a plurality of other amorphous sections.
